(19) United States
(12) Patent Application Publication
(10) Pub. No.: US 2010/0301148 A1
(43) Pub. Date: Dec. 2, 2010

(54) BOTTLE CRUSHER

(76) Inventors: JAMES L. ARNONE, Macomb Township, MI (US); DANIEL S. VERGOTE, Warren, MI (US)

Correspondence Address: CARGILL & ASSOCIATES, P.L.L.C., 56 MACOMB PLACE, MT. CLEMENS, MI, 48043, US

(21) Appl. No.: 12/790,447

(22) Filed: May 28, 2010

Related U.S. Application Data
(60) Provisional application No. 61/183,055, filed on Jun. 1, 2009.

(51) Int. Cl. B02C 19/00

(52) U.S. Cl. 241/25; 241/99

(57) ABSTRACT

Disclosed are various aspects of a new and more advantageous compact bottle crusher for safely pulverizing empty glass bottles in commercial establishments such as restaurants and bars which includes an upper staging area including a carousel, an electric crushing unit attached to a sealed collection barrel in order to pulverize glass bottles into small pieces of glass, and a housing for a collection barrel. The carousel may be a rotary bottle cradle carousel and may be manually or automatically indexed for 12, or up to 24 bottles or more. The crushing unit is designed to be run off of normal 110 volt electricity, and is utilized to achieve essentially pebble or pea-sized pieces of glass by utilizing various methods, including hydraulic pistons, breaking anvils, rotating veins, crusher fins, or plunger units, such as a moveable jaw and a stationary jaw. Rotating units cause repeated impact which provides a pulverized smaller glass fragment. The crushing unit may also include sound deadening materials in order to make it more amenable for use behind a bar in a drinking establishment.

### BACKGROUND OF THE INVENTION

1. Field of the Invention

The present invention relates to the crushing and compaction of glass bottles for disposal or recycling. More particularly, the present invention relates to the on-site crushing of bottles in anyplace that serves beverages, and accepts return bottles, including, but not limited to cocktail bars, lounges, party stores, grocery stores, bowling alleys, and convenience stores for volume reduction, compaction and subsequent disposal and/or recycling.

2. Description of the Prior Art

In many food service establishments, for example, bars, restaurants and lounges, the storage of empty glass containers such as soft drink bottles, beer bottles, wine bottles and the like, poses problems due to limited storage space and accidental breaking which can result in hazardous conditions. Moreover, regardless of how they are disposed of, bottles require storage space prior to being carted away to a disposal or recycling facility. That is, the bottles must be stored until transportation for recycling or disposal can be arranged.

In a typical bar, where there is a great deal of beer served in bottles, a beer truck delivery driver customarily comes into the establishment, count the number of empties that relate to the brand of beer that he services, see whether or not the bottles are his product, load 5 or 6 cases of empties into his truck and then return with a check made out to the bar. In this method, the bottles remain whole and then they are taken to the distributor where they are crushed. This method generally worked fine, except that the truck driver needed to leave an equal amount of space on his delivery truck as empty in order to receive the recycled bottles that he was picking up at the drinking establishment. In other words, if he brought 20 cases of beer to a bar, he would probably be returning with 20 cases of empty beer bottles. Consequently, his truck would have to have space filled with his full cases, while leaving room for returning empty cases. If the bottles had already been crushed, and were placed into a barrel, where the ratio of space required for crushed bottles is approximately one fifth (⅕) or one sixth (⅙) that of full bottles, the driver would be able to utilize more space for delivering his beer. Consequently, it would be a real advantage to a beer delivery and distributor company to be able to pick up crushed bottles, rather than whole, empty bottles.

Therefore, as can be seen from the above paragraphs, there is an advantage for the bar owner, as well as an advantage for the beer delivery man. Furthermore, the distributor does not have to take his efforts to crush all of the glass, as the glass would already be crushed.

With regards to another aspect of this industry that can be addressed, stopping theft of bottles which are re-run through the bottle return system is desirable. Hundreds of thousands of dollars can be alleviated from theft because once a bottle is crushed, it cannot be returned again. For example, after whole bottles are recycled and the deposit money has been reimbursed to the original purchase, a worker at a bottle recycling facility can take possession of the whole, recycled bottles, and can then take them out of his establishment, after his boss has already reimbursed the person who has brought back the bottles. The employee can then take the bottles that have already been reimbursed once to yet another facility, and take a second reimbursement for himself and his own pocket. Since 13 states utilize the return bottle procedure, this is a widespread problem.

As a matter of fact, bottle deposit fraud had become severely problematic in the State of Michigan where it is estimated that it costs the state approximately $10 million per year, in addition to $1.5 million per year by redeeming cans and bottles for which no deposit had ever been paid. In fact, one of the “Seinfeld” episodes shows the characters of Kramer and Newman as men who once tried to drive a mail truck full of empty cans and bottles from New York to Michigan to profit from the state's dime deposit law. Although this may be very funny on television, illegal returns are a real life problem, and crushed bottles would not be available to be returned. Law enforcement agencies have broken up bottle return rings, and currently a trial for 12 defendants is scheduled to begin soon in Macomb County, Michigan.

Color separation is yet another aspect of the collection of empty bottles, adding millions of dollars worth of labor force, time and energy needed to separate bottles into their various colors for recycling. For example, a clear or white bottle can fetch ten cents per pound recycled, while a brown bottle is five cents a pound and a green bottle is four cents per pound. Traditionally, the beer delivery driver would come into the establishment, separate his product, by color into the various boxes, and then take them back to his main distributor, where the colored bottles again have to be separated and crushed all together. Mixing the colors in with the recycled materials, causes a huge problem for the recycler, and renders the product unusable, or worth much less money as a “mixed” recycled product. By keeping the colors separated, the recycled materials are worth more money, and, consequently worth more to the distributor. Only under certain circumstances, and for certain recycled product's buyers, the colors can be mixed.

Conventional bottle crushing units cost can cost tens of thousands of dollars, some units costing as much as $100,000. Traditionally, these units are huge, certainly too large to be put behind a bar in a drinking establishment or restaurant. The contents of the crushed glass containment unit must be small enough to be handled by a normal sized human, such as a beverage delivery truck driver, in order to make it a feasible remedy to recycling and crushing bottles in a drinking establishment. Such a unit needs to be inexpensive and compact enough to have it make sense to be purchased by the drinking establishment owner, and consequently also needs to be feasible for the beverage delivery system, as well as the beverage distribution company owner. As long as the crusher fills all of the needs of those four systems, i.e. the bar owner, the beverage delivery man, the recycler and the distributor, then the cost can be justified in a relatively short period of time if the unit is compact enough to not use too much real estate within the bar.

Even at establishments that do not recycle (that is where bottles are disposed of as trash) storage is a concern because of the time and effort required in handling and transporting the bottles. In a bar, for example, trash bins located behind the bar tend to fill quickly since each empty bottle takes up a considerable volume in the bin. As a result, bottle or trash bins must be manually carried and generally frequently to a dumpster that may be located outside of the building. In addition, the bottle bins behind the bar can take up valuable space and can interfere with the efficient movement of the bartender or waiter. As a result, valuable floor space is often wasted on storing empty bottles in crates or other containers until the bottles can be delivered to or picked up by a disposal or recycling facility. The use of storage space can become an acute problem in bars and restaurants where large numbers of empty glass bottles can result from even one evening's operation.

In an effort to address this problem, devices are known that pulverize glass bottles and contain the pulverized glass. Such devices usually use a pulverizing blade located within a somewhat isolated chamber to reduce the glass volume by breaking the bottles into small pieces of glass. However, such devices produce glass shards and/or glass dust, and often cannot adequately contain the pulverized glass. It has been found that in such a known system, glass shards and dust tend to escape into the surrounding areas and the glass that is pulverized often is not in sufficiently small fragments to permit readily handling the glass material.

Accordingly, there is a need for a safe and effective compact bottle crusher. It would be of a great advantage to the industry if there was provided a bottle crusher that is self-contained within a relatively small package or unit; that crushes the glass within an isolated chamber such that glass shards are retained in a removable container; and that eliminates regions, such as in brushes or the like, in which contamination can collect resulting in bacterial growth.

### SUMMARY OF THE INVENTION

In accordance with the present invention, there is disclosed various aspects of a new and more advantageous compact bottle crusher for safely pulverizing empty glass bottles in commercial establishments such as restaurants and bars which includes an upper staging area including a carousel, an electric crushing unit attached to a sealed collection barrel in order to pulverize glass bottles into small pieces of glass, and a housing for a collection barrel. The carousel may be a rotary bottle cradle carousel and may be manually or automatically indexed for 12, or up to 24 bottles or more. The crushing unit is designed to be run off of normal 110 volt electricity, and is utilized to achieve essentially pebble or pea-sized pieces of glass by utilizing various methods, including hydraulic pistons, breaking anvils, rotating veins, crusher fins, or plunger units, such as a moveable jaw and a stationary jaw. Rotating units cause repeated impact which provides a pulverized smaller glass fragment. The crushing unit may also include sound deadening materials in order to make it more amenable for use behind a bar in a drinking establishment.

A sealed collection container may be attached to the output of the crushing unit, and helps to protect the operator from contact with glass shards, smells from old bottles, and may alleviate any potential insect issue. A liquid drain is optional in order to allow excess fluid to be drained away from the broken glass. An optional shard and dust shield may also be utilized. To operate the present invention, a first aspect of the invention includes the use of a floor pedal to push the collection barrel against the output of the crushing unit to seal the barrel against a seal to contain the dust, shards, and smell.

Additional aspects of the present invention may include a scanner to identify the bottles and read the barcodes, a color selector to provide determination of which bottles will be accepted at a particular time, a kick-out rejecter to spit back bottles that will not be accepted, a counter and resetting capability in order to enable a pickup driver to start fresh with each pickup, a printer to provide labels for the various barrels, weight scale to determine when the barrel is full, and a cabinet for attractively housing all the components.

### BRIEF DESCRIPTION OF THE DRAWINGS

For a further understanding of the nature and advantages of the expected scope and various embodiments of the present invention, reference shall be made to the following detailed description, and when taken in conjunction with the accompanying drawings, in which like parts are given the same reference numerals, and wherein:

FIG. 1 is a front perspective view of a first aspect of a bottle crusher made in accordance with the present invention;

FIG. 2 is a back perspective view of the bottle crusher with the cabinet door open;

FIG. 3 is a partial view of one aspect of the crushing unit;

FIG. 4 illustrates a partial perspective view from underneath of the crushing unit;

FIG. 5 illustrates a top plan view of a portion of the carousel unit;

FIG. 6 is a side elevational cutaway view of the entire mechanism in accordance with the present invention;

FIG. 7 is a side elevational view of yet another aspect of the present invention; and

FIG. 8 illustrates details of a crushing piston of the bottle crusher in accordance with yet another aspect of the present invention.

### DETAILED DESCRIPTION OF THE INVENTION

While the present invention may comprise various aspects and embodiments of the present invention which may take various forms, there is shown in the drawings and will hereinafter be described, at least a first aspect of a preferred embodiment with the understanding that the present disclosure is to be considered an exemplification of the invention and is not intended to limit the invention to the specific embodiment, size or shape illustrated. It should be further understood that the title of this section of this specification, namely, “Detailed Description of the Invention”, relates to a requirement of the United States Patent Office, and does not imply, nor should be inferred to limit the subject matter disclosed herein.

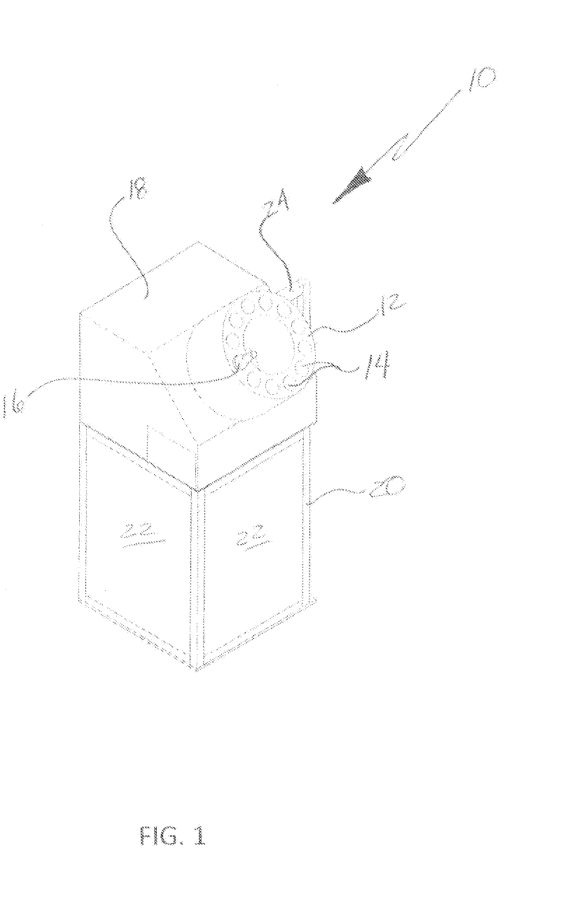

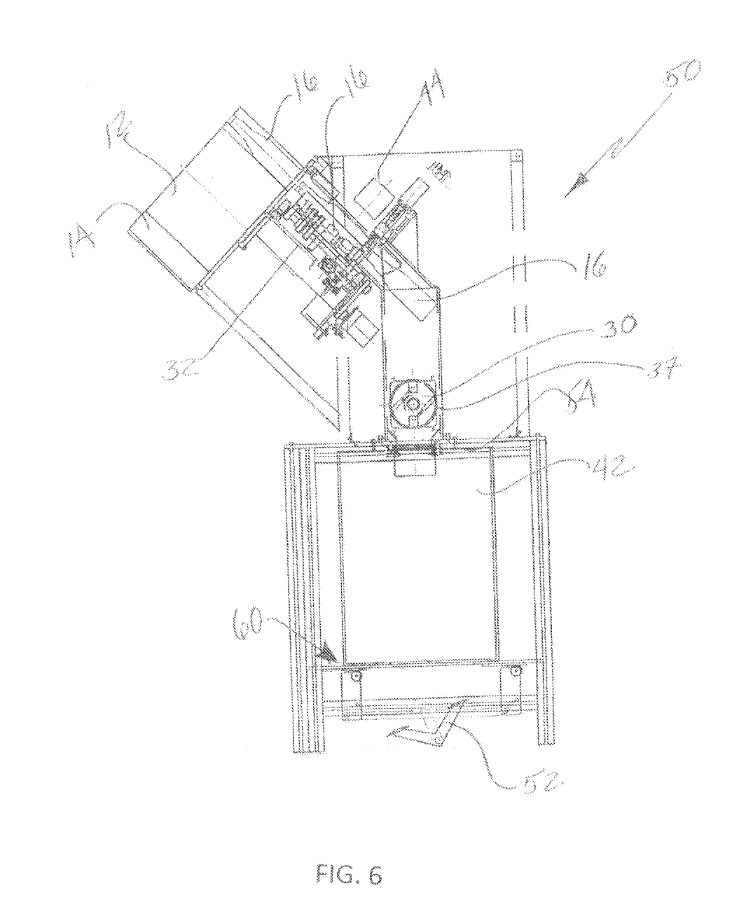

Referring first to FIG. 1, there is shown a new compact bottle crusher manufactured in accordance with the present invention, and generally denoted by the numeral 10, including a bottle carousel 12, having bottle chutes 14 therein radially placed about the exterior circumferential perimeter designed to hold a conventionally sized beverage bottle 16. The crusher housing 18 surrounds and protects a crushing unit, as more fully described herein below. Cabinet stand 20 is used to house a container such as a barrel, a bucket, a drum, a heavy plastic bag (either alone or in a container, or any other type of collection container (not seen in this figure, but seen in greater detail hereinafter with regard to FIG. 6). Cabinet panels 22 are used to cover the container or barrel that is not shown, and is supported by the cabinet stand. Cabinet door 24 is shown in the open position from the side of the bottle crusher unit 10.

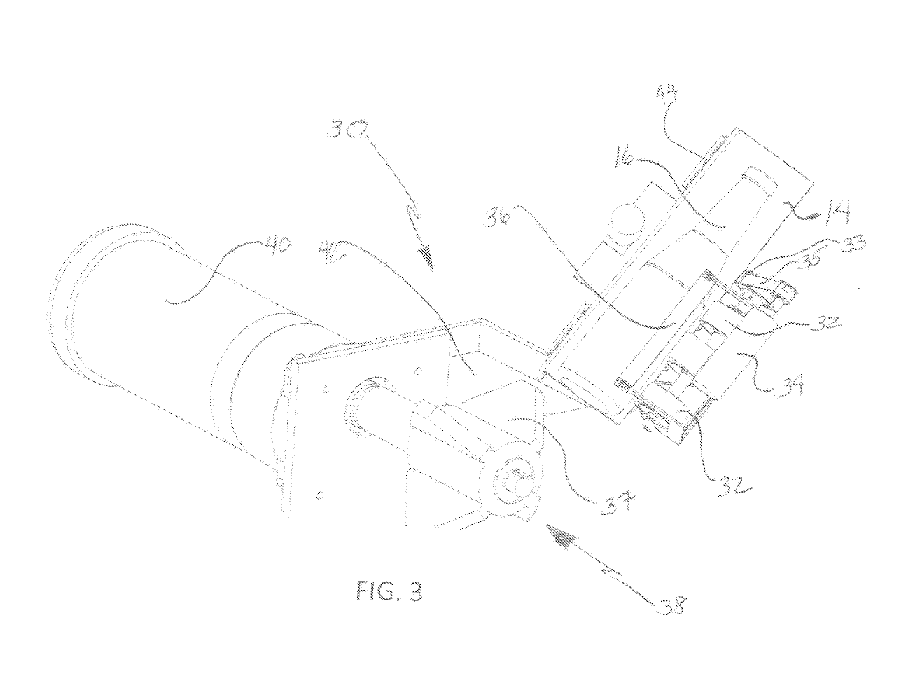

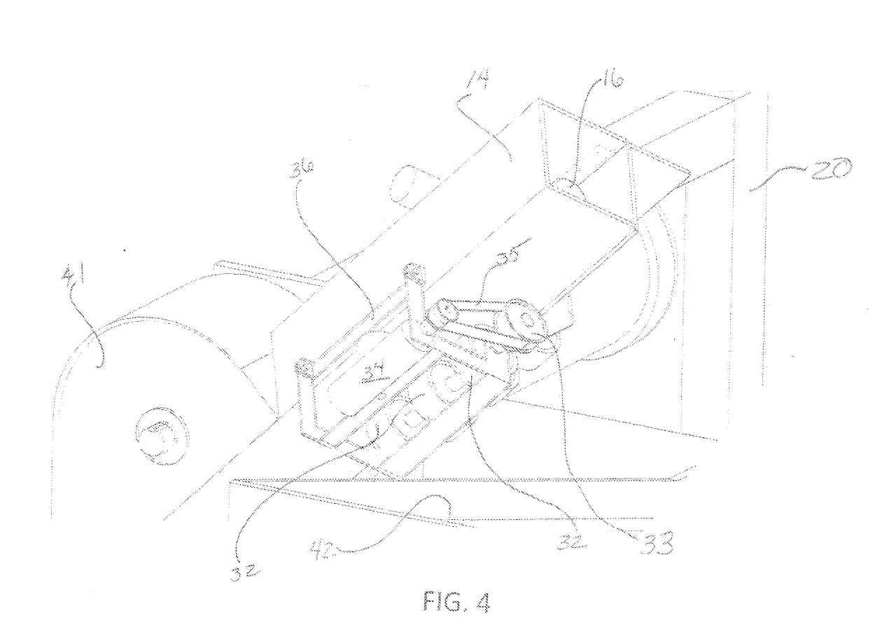

In operation, carousel 12 is loaded with bottles 16 into bottle chutes 14. In one aspect of the invention, a floor pedal (as shown in FIG. 6) is used to raise up the collection barrel inside cabinet stand 20 to receive the crushed bottles 16 after the operation. Once the barrel is full, whether the determination is made visually, through the use of a weight scale, a photoelectric sensing device, or any other sensor that is suitable for use to determine that the barrel if full, the barrel may be interchanged. Carousel 12 may be manually or automatically indexed from space to space to make filling the bottle chutes 14 easier. Carousel 12 may hold from 12 up to 24 bottles at a single time, and may be in electrical communication with a counter, whether a manual counter or a programmable logic circuit counter. In yet another aspect of the present invention, the counter may be reset so as to provide a new starting point for a driver to determine the amount of bottles that were crushed, alleviating the issue of having to manually count the bottles he was returning. During the operation of the crushing unit, the carousel may rotate radially to drop the bottles against a scanner bar contained therein, as shown in greater detail herein below with reference to FIG. 3, et al.

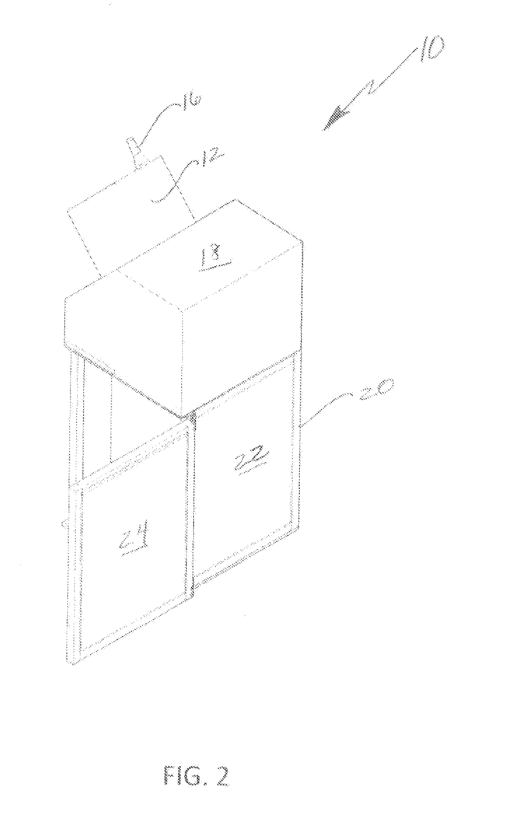

To view the back of FIG. 1, FIG. 2 illustrates the same bottle crusher unit 10, but only shows the cabinet door 24 in the open position.

A more explicit aspect of the present invention includes a crushing unit 30 shown in FIG. 3, where bottle 16 is dropped down through chute 14 and is rotated by rollers 32 activated by electric motor 34. A scanner 36 is positioned properly within chute 14 to be able to read the barcode on the side of the bottle, or to select a color, or to provide the information necessary for the printer to print out a label for the container, whether there is a plastic bag liner or not, so that it may be more easily identified after the delivery man picks up the container of crushed glass and returns it to the beverage distributer house. After bottle 16 has been identified, color selected, and was not kicked out, the bottle can continue on its downward path into the crusher fins 37 of the crusher fin or pulverize head 38 as rotated by electric motor 40. Electric motor 40 shall be different from the rotating electric motor 34 which by use of a drive belt 35 and drive 33, the rotator wheels 32 spin the bottle 16 so that the barcode, along with all the other information.

Referring again to FIG. 3, once bottle 16 is pulverized by fins 37, the refuse and pulverized shards of glass are allowed to fall into a container lined with a heavy duty plastic bag 42 for recycling and/or proper disposal.

FIG. 4 illustrates an underneath perspective view of the aspect of the invention shown earlier in FIG. 3, in which the bottle chute 14 has contained therein a bottle 16 which contacts rotator wheels 32 that are driven by a drive 35 attached to a drive 33 which is rotated by a drive belt 35 from electric motor 34. Attached proximally is an optical scanner bar 36 that is preferred for yet another aspect of the present invention. A collection barrel 42 is shown in place underneath the location where the bottles are pulverized (crushing fins not shown). Pulverizer motor housing 41 is used to protect glass shards from being released during the operation of crushing, where all of this is located within cabinet stand 20.

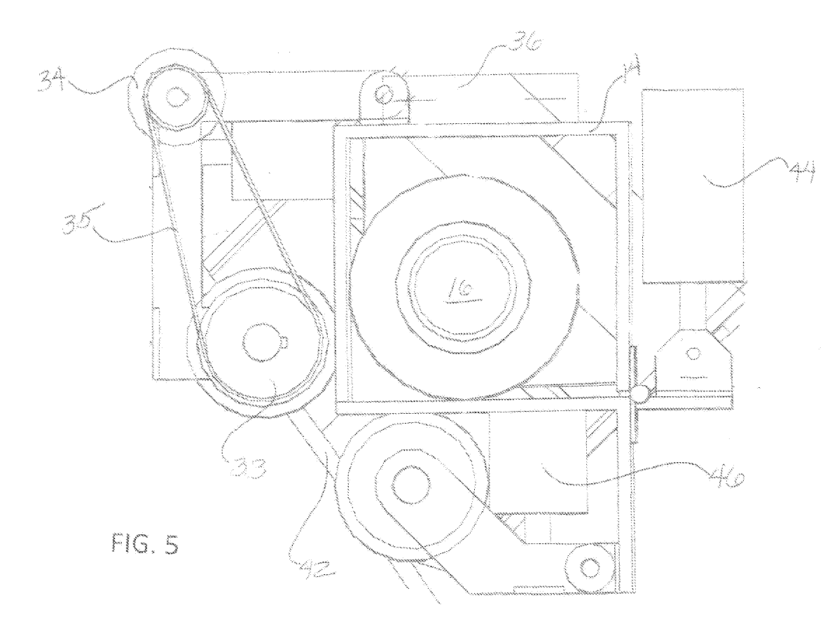

FIG. 5 is a top plan view of the rotational mechanics of the above described aspect of the present invention in which bottle 16 is shown encased in bottle chute 14. Motor 34 is driven by rotational attachment through as drive belt 35 to a rotator wheel 33 which spins bottle 16 so that scanning device 36 can read all the information from the bottle 16. Collection container 42 is located thereunder in order to catch falling debris which is gravity fed into collection container 42 to be disposed of properly one way or another at a later time. The collection container may be lined with a plastic bag to ease disposal. Both the color decoder and the barcode or UPC Code reader/scanner 44 are in plain view of the bottle as it is spinning, and counter 46 may be utilized to keep a proper tabulation on the number of bottles fed into it, as well as for maintaining records for the state and distributorship when reimbursement of the bottle deposit is made. An onboard computer may find utility to facilitate keeping track of bottles, labels, etc.

FIG. 6 is a side elevational view of the cutaway version of one aspect of the present invention. The bottle crusher unit is generally denoted by numeral 50, and it will have element numbers similar to the other figures, wherein carousel 12 has bottle chutes 14 therein for containing bottles 16. The angle of the carousel is adapted for leaning bottles 16 against a rotating mechanism 32 so that barcode scanner 44 and the color decoder (not shown here) can read the information off the bottle 16. Once bottle 16 drops down toward the crushing unit 30, crusher fins 37 pulverize the bottle into glass pieces and glass shards that fall into collection barrel 42. Foot pedal 52 is utilized to activate the bottle lift system 60 so that the collection barrel 42 comes into contact with a lower seal 54 of the crushing unit 30 so as to prevent any glass dust, shards, or smell from emanating out of the collection barrel.

The carousel may include a rotary bottle or a cradle carousel aspect, and may include many other features including, but not limited to, the bottle counter, number resetter, barcode scanner, identification unit, color decoder/selector, printer for labels for the barrel, kick out rejecter machinery, or any other number of optional features which may be commercially available and attached thereto.

The crushing unit is preferably electric, i.e. 110 volts, so that it just may be plugged into any wall socket and be easily installed in a bar or restaurant establishment. The crushing unit shall achieve crushed glass pieces and shards from a whole bottle. These somewhat larger pieces are then individually crushed to potentially achieve pea-sized pieces. The crushing unit may include, but is not limited to, the above described rotating crusher fin design, and may also include a crusher piston design as well as a moveable jaw in conjunction with a stationary jaw. With such a moveable and stationary jaw, one aspect may include the use of a ram on a hydraulic piston, or a rotating fin with breaking anvils used to pulverize.

Other aspects may include plunger designs, crusher fins, or pulverizing anvil designs. Rotation is yet another aspect of the present invention, whereby having repeated impact by the fins causes the bottles to pulverize into smaller glass fragments than hydraulic, or ram crushing. In these aspects of rotation, the rotation speed may be from about 10 RPM to about 50, 000 RPM.

In order to maintain a quiet environment, so that its noise generation level can easily be tolerated within a drinking or eating establishment, sound deadening material may be utilized. Such a sound deadening material may include close celled foam, packing material, other commercially available sound deadening materials, or any combination thereof. The sound deadening material may be established in and throughout the entire housing, cabinet stand, and around the carousel rotation, or only in portions surrounding the crushing mechanism.

Yet another aspect of the present invention is the utilization of the sealed collection barrel which would alleviate the creation of glass shards, glass dust, noxious fumes and smells, and maintaining a sealed container would also help to alleviate bugs, flies, and other flying insects.

Chlorine tablets, or any other effective deodorizing mechanism, may be advantageous. Chlorine tablets added to the bottle crushing drum area help to kill bacteria that generate foul odors. Enzymatic powders or solutions may also be incorporated. Further, anti-microbial coatings on the housings can be permanent stench deterrents.

The sealed collection barrel of this aspect may include a five (5) to one hundred (100) gallon collection barrel, which would be attached to a weight scale in order to tell that the barrel was full. An optional plastic liner bag may be used, such as a 6 MIL thick 40-50 gallon polybag available from U-Line Corporation of Chicago, Ill. Previously, other methods of determining whether or not the barrel was full were already disclosed concluding visual methods, photo-electric detectors, or other commercially available units. It has been found that generally 10 cases of beer bottles weigh about one hundred (100) pounds. Consequently, a barrel that would be able to hold 10 cases of empty beer bottles would be of a great advantage. These capacities have been selected to allow a delivery man to pick up the collection barrel without any physical damage.

In order to facilitate bottle exchange, the container itself may ideally be of a rectangular configuration, although any suitable shape may be employed. A square barrel lined with a plastic bag, allows for easier stacking and easier placement onto a hand truck for delivery out to the delivery truck from the establishment. A neoprene or neoprene-type seal and shield may be employed at the bottom of the crusher unit where the connection is with the collection container. Having an upper neck on the collection barrel which is complementary to the neoprene-like shield or seal, another aspect of the present invention includes a lifting mechanism for bringing the seal of the collection barrel to mate with the seal of the crushing unit, thereby providing a water-tight seal for collecting the glass shards and dust.

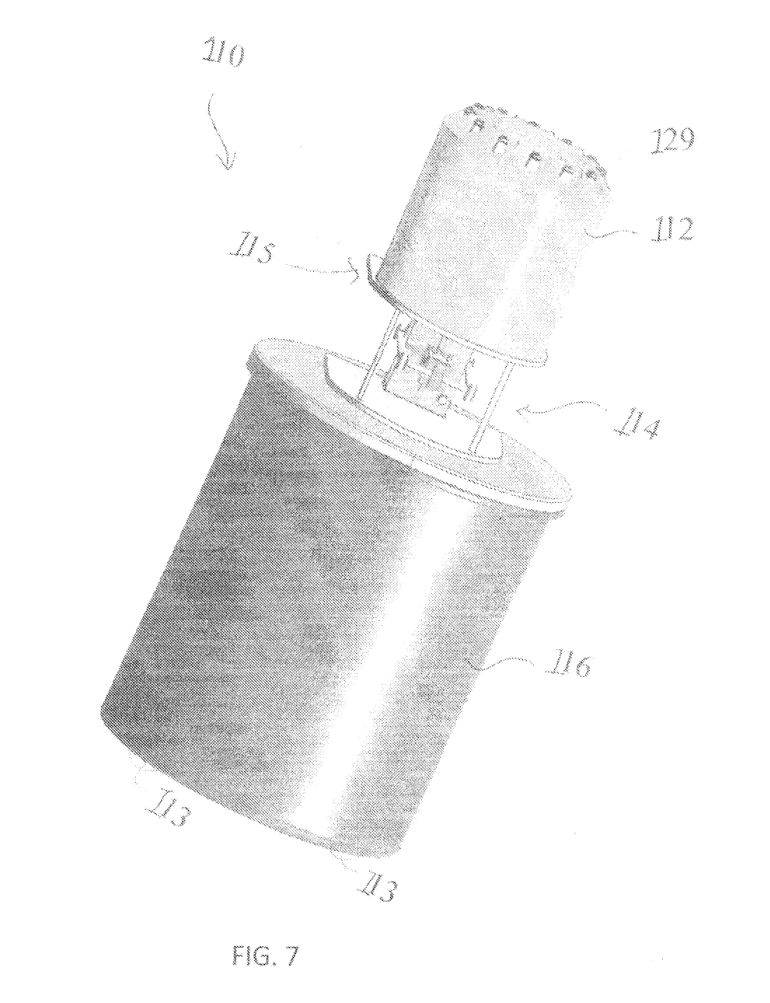

Referring now to the remaining drawings in detail, yet another aspect of the present invention is shown in FIG. 7 where a front view of a bottle crusher is generally indicated by the numeral 110, which also includes a rotatable carousel 112 to receive empty glass bottles, a crushing piston 114 mounted underneath the rotatable carousel 112 to crush the empty bottles and a removable glass receptacle 116 for receiving crushed glass fragments.

The rotatable carousel 112 is attached to a frame generally indicated by the numeral 115 includes a plurality of vertical passageways for receiving and temporarily holding empty glass bottles 129 such as beer bottles, soda pop bottles, wine bottles and the like. The rotatable carousel 112 may have an aperture on the bottom thereof for dispatching the glass bottles to the crushing piston 114 one at a time. Embodiments of the apparatus can be constructed to hold any number of glass bottles. It is preferable to hold from twelve (12) up to twenty four (24) bottles. However, such embodiments should be constructed so that during the crushing of glass bottles, the glass bottles on the carousel 112 do not interfere with one another.

The carousel 112 may be rotated manually or automatically. In an example of an automatically rotating carousel, a drive element may be mounted to the carousel 112. The drive element may also be mounted inside carousel 112. However, as is readily appreciated by those having ordinary skill in the art, the drive element can be mounted anywhere, as long as it can rotate the carousel 112. In one preferred embodiment, the drive element can comprise a motor attached to the carousel 112 using, for example, a spindle or a suitably arranged gear mechanism. The rotation rate and/or the time for rotating the carousel 112 can be controlled using a suitable control element.

For example, the control element can be an electronic control element such as a microprocessor, an ASIC (application specific integrated circuit) or any other suitable electronic system. The control element can be an independent electronic system or comprise a part of a larger computer controlled system. Such control can be established using a GUI (graphical user interface) or any other control interface known to persons having ordinary skill in the art. An onboard computer is ideal for performing any and all tabulation functions and printer functions for labels, and may be included.

The glass receptacle 116 for receiving crushed glass fragments may be made of any suitable material such as plastic, metal or wood. In addition, there may be an optional disposable liner made of plastic, paper, or any other suitable material, so that the glass receptacle may remain in service while the optional collection liner may be removed and replaced. As is readily appreciated by those having ordinary skill in the art, glass receptacle 116 can be any kind of shape, as long as it can receive crushed glass fragments from the crushing piston 114. Preferably the surrounding walls of the receptacle 116 may be slightly tapered from top to bottom, so that the receptacles are stackable, one upon another. The glass receptacle 116 may optionally have a removable cover, or wheels for easy transport.

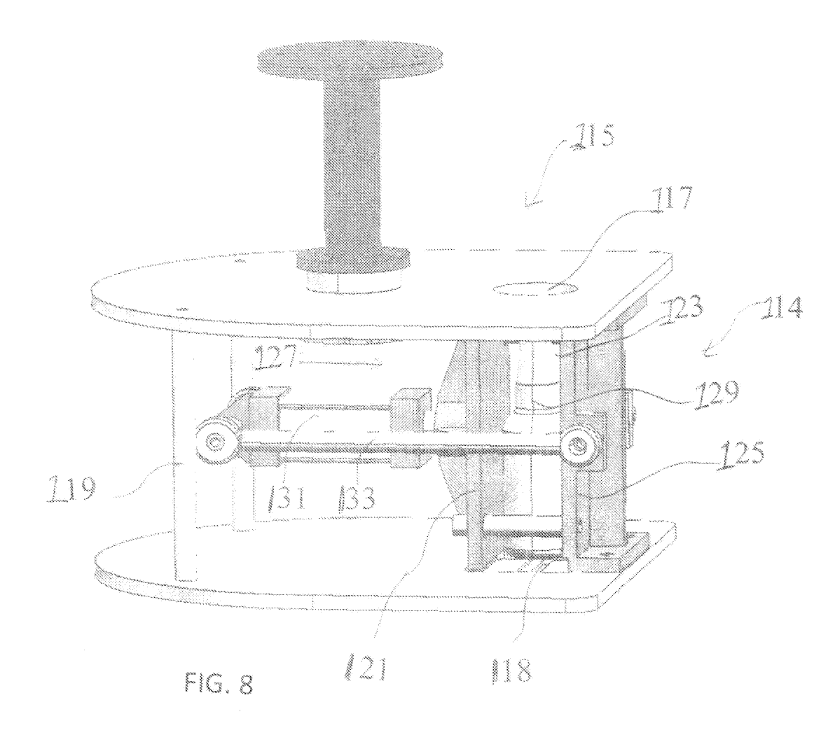

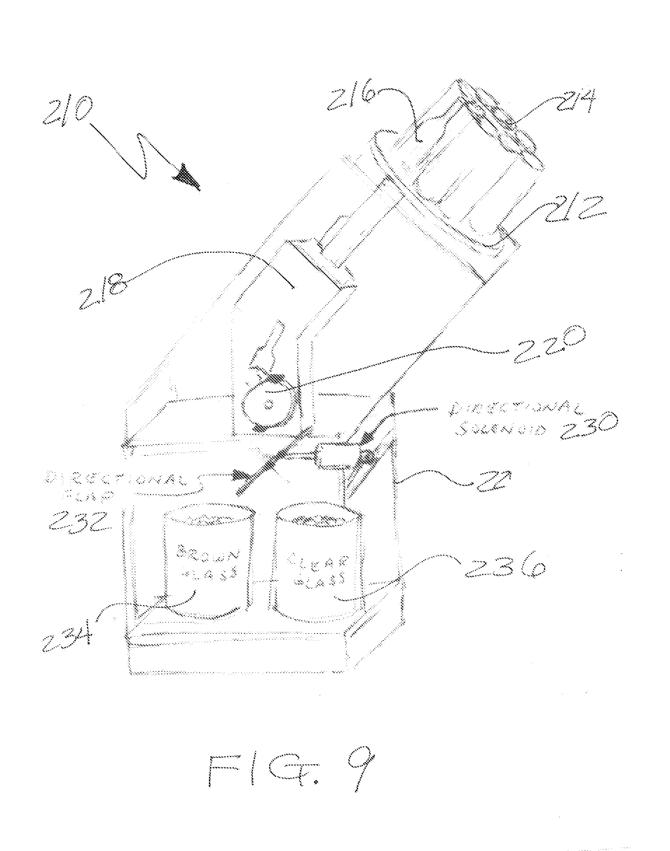

FIG. 8 illustrates details of this aspect of the present invention including a crushing piston 114 of the bottle crusher 110. The crushing piston 114 is mounted inside the frame 115. Frame 115 may include two horizontal plates and at least two vertical supporting legs 119. The upper plate preferably includes an opening 117 to receive the bottles from the carousel 112 and the bottom plate preferably has a slit 118 to release the crushed glass fragments. The crushing piston 114 has a working face 121 which, in the retracted position of the crushing piston, is generally aligned beneath the upper plate and forms an additional end wall for a crushing chamber 123 in opposed relation to a fixed end wall 125. The fixed end wall 125 is mounted between the two horizontal plates of the frame 115. Thus, bottles may be dropped by gravity into the rushing chamber 123 and generally in vertical alignment whereby as the crushing piston 114 is moved to the right, as viewed in FIG. 2 and in the direction of the arrow 127, forces are applied to a bottle 129 for crushing thereof to a compact size.

The crushing piston 114 is moved by various means, including the use of a hydraulic, pneumatic or electric motor utilizing a cylinder 131 bolted to the vertical supporting legs 119 and preferably having a pair of rods 133 connected to the fixed end wall 123 of the crushing piston 114. The cylinder 131 may be a double-acting cylinder. The crushing piston 114 may move from the retracted position to the advanced position for crushing of bottles followed by retraction of the crushing piston 114.

It is also possible to include multiple crushing units where a greater number of bottles may be crushed. Indeed, the crushing unit may be active in both directions, i.e., crushing bottles on either side of a bi-directional ram block. Multiple crushing units may be included in another aspect of the present invention to gradually crush the glass pieces and shards into respectively smaller pieces of glass, such that the desirable pea-sized pieces of glass are achieved in a multiple step approach. In this aspect, additional crushing units may be incorporated into the overall crushing unit.

During the operation, glass bottles are placed into the opening of the rotatable carousel 112 one after another. Individual glass bottle 129 is dropped through the opening 117 on the top of the frame 115 into the crushing chamber 123. The long axis of the bottle 129 is substantially parallel to the long axis of the working face 121 and the fixed end wall 125. After crushing by the crushing piston 114, the glass fragments, shards or dust fall down by gravity through the slip 118 into the moveable glass receptacle 116. The crushing piston 114 may be connected to a conventional 110 volt power outlet. When the power is turned on, the crushing piston 114 may be operating in the range of about 2000 kPa to about 7000 kPa (about 300 psi to about 1000 psi).

Referring last to FIG. 9, there is shown another aspect of the compact bottle crusher manufactured in accordance with the present invention, and generally denoted by the numeral 210, including a bottle carousel 212, having bottle chutes 214 therein radially placed about the exterior circumferential perimeter designed to hold a conventionally sized beverage bottle 126. The crusher housing 218 surrounds and protects a crushing unit, as more fully described herein below. Cabinet stand 220 is used to house a container such as a barrel, a bucket, a drum, a heavy plastic bag (either alone or in a container, or any other type of collection container (not seen in this figure, but seen in greater detail hereinabove with regard to FIG. 6). Cabinet panels 222 are used to cover the container or barrel that is not shown, and is supported by the cabinet stand. Cabinet door 224 is shown in the open position from the side of the bottle crusher unit 210.

In FIG. 9, the difference between this aspect and the preliminary aspect shown and described with reference to FIG. 1-6 is the addition of a directional solenoid 230 which, when activated by the color coder scanner described above, a directional flap 232 is activated to put the crushed glass fragments into either a container for brown glass 234 or a clear glass container 236. Of course, any color desired may be collected individually. In addition, there may be additional solenoids and flaps for directing the various colors of glass into their own respective collection containers (not shown in this Figure).

The bottle crusher of the present invention provides several advantages. It is self contained within a relatively small package or unit for volume reduction and compaction. It crushes the glass within an isolated chamber such that glass shards or dust are retained in a removable container and will not escape into the surrounding areas so that the bottle crusher is a safe device. It eliminates regions, such as in brushes or the like, in which contamination can collect resulting in bacterial growth. In summary, numerous benefits have been described which result from employing any or all of the concepts and the features of the specific embodiment of the present invention, or those that are within the scope of the invention.

The process for utilizing the bottle crusher that is made in accordance with the present invention involves various steps, including but not limited to the following process steps. In a drinking and eating establishment, empty bottles are inserted into the bottle crushing unit, and the crusher automatically crushes the bottles. When the collection barrel is determined to be full, particularly through the use of one of the devices described hereinabove, the establishment manager may insert an optional USB or flash drive into the control mechanism, or onboard computer of the bottle crushing unit to receive pertinent data and information. The bottle count and bottle type information will be downloaded onto the flash drive so that this data and information can be downloaded to a computer for accounting purposes. In addition, this data can be used to label the barrel. Then, the barrel, or its plastic liner bag, is removed from the crushing unit and the operator will install the barrel lid and label the bag. The full bag would be placed in an area for distributor pick up in the establishment, and an empty barrel will be placed into the collection barrel unit, ready for use.

In the next step, a beverage distributor employee will enter the drinking and eating establishment to deliver full bottles of product as normal. The driver will meet with drinking establishment personnel, and will easily review the crushed bottle count and will credit the drinking establishment for returnable bottles as normal. The beverage distribution driver will unload the empty barrels, if disposable bags are not used, and their respective lids into the drinking establishment to replenish those barrels once the collection barrels become full. In yet another aspect of the present invention, that driver will utilize a modified hand truck to lift full barrels, or plastic bags filled with crushed glass onto his truck. These full bags can be loaded onto a pallet for easy removal by a high-lo driver later on or they may be stacked separately, depending on the desires of the driver.

Upon arrival to the beverage distributor warehouse, the driver will pull into the warehouse at the end of his daily route as normal. The full barrels of crushed glass can be removed by any feasible means, including a forklift truck, to unload the full crushed glass barrels into a conventional staging area where the warehouse normally empties barrels or boxes of empty bottles. In this instance, the warehouse will empty the collection barrel containing all the crushed glass into a foundry or recycler container for their pick up. Alternatively, the warehouse can leave the full crushed glass barrels in tact for pick up by a glass foundry or recycler. Then, empty barrels may be staged for delivery to the drinking and eating establishment at their next regularly scheduled stop.

The foregoing description of a preferred embodiment of the invention has been presented for purposes of illustration and description. It is not intended to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated.

What is claimed is:

1. A bottle crusher, comprising:
an upper staging area including a carousel, and an electric crushing unit for pulverizing glass bottles into small pieces of glass;
a collection barrel attached to the electric crushing unit for receiving the small pieces of glass; and
a housing for containing the collection barrel; said carousel being indexed for at least one and up to 24 bottles or more.

2. The bottle crusher of claim 1, wherein said crushing unit is designed to be run off normal 110 volt electricity, and is utilized to achieve essentially pebble or pea-sized pieces of glass.

3. The bottle crusher of claim 1, wherein said crushing unit utilizes any crushing mechanism method, including those selected from the group consisting of hydraulic pistons, breaking anvils, rotating veins, crusher fins, plunger units, such as a moveable jaw and a stationary jaw, and combinations thereof.

4. The bottle crusher of claim 1, wherein said crushing unit including rotating units for causing repeated impact which provides a pulverized smaller glass fragment.

5. The bottle crusher of claim 1,
wherein said crushing unit may further comprise sound deadening materials in order to make it more amenable for use behind a bar in a drinking establishment.

6. The bottle crusher of claim 1, wherein said sealed collection container may be attached to the output of the crushing unit, to help protect the operator from contact with glass shards, smells from old bottles, and further alleviates potential bees or other insect issues.

7. The bottle crusher of claim 1, further comprising a liquid drain in order to allow excess fluid to be drained away from the broken glass.

8. The bottle crusher of claim 1, further comprising a shard and dust shield to alleviate injuries to the operator.

9. A method of crushing bottles, comprising:
inserting empty bottles into a bottle crushing unit;
activating the crusher to count the bottles and automatically crush the bottles and deposit the crushed bottles into a collection barrel;
determining when the collection barrel is full;
inserting a USB or flash drive into an onboard computer of the bottle crushing unit to receive pertinent data and information;
downloading the bottle count and bottle type information onto the flash drive so that this data and information can be downloaded to a computer for accounting purposes; and
removing the barrel, or its plastic liner bag, from the crushing unit and labeling the bag.

10. The method of crushing bottles of claim 9, further comprising an additional step of a beverage distributor employee entering the establishment to deliver full bottles of product and reviewing the crushed bottle count and crediting the drinking establishment for the appropriate number of returnable bottles.

11. The method of crushing bottles of claim 9, further comprising a step wherein the beverage distribution driver unloads the empty barrels into the drinking establishment to replenish those barrels once the collection barrels become full.

12. The method of crushing bottles of claim 11, further comprising a step of the driver utilizing a modified hand truck to lift full barrels, or plastic bags filled with crushed glass onto his truck, whereby the full bags can be loaded onto a pallet for easy removal by a high-lo driver later on or they may be stacked separately, depending on the desires of the driver.
